(19) United States
(12) Patent Application Publication
(10) Pub. No.: US 2023/0214395 A1
(43) Pub. Date: Jul. 6, 2023

(54) FAST AND SLOW RESOURCE POOLS FOR QUERY EXECUTION

(71) Applicant: VMware, Inc., Palo Alto, CA (US)

(72) Inventors: Iva KOLEVA, Sofia (BG); Antoni IVANOV, Sofia (BG); Dako DAKOV, Sofia (BG)

(21) Appl. No.: 17/647,338

(22) Filed: Jan. 6, 2022

(51) Int. Cl. G06F 16/2455

(52) U.S. Cl. CPC G06F 16/24564

(57) ABSTRACT

A method for query execution using a dual-resource pool design (e.g., a fast resource pool and a slow resource pool design) is provided. The method includes receiving a first query requesting retrieval of first data from a database, admitting the first query to a fast resource pool for execution, wherein the fast resource pool is configured with one or more thresholds for execution, executing the first query in the fast resource pool using resources allocated to the fast resource pool, during execution of the first query in the fast resource pool, determining the one or more thresholds for execution have been exceeded, admitting the first query to a slow resource pool for execution, and executing the first query in the slow resource pool using resources allocated to the slow resource pool.

### BACKGROUND

In database systems, to access, retrieve, and process stored data, a query is generated, automatically or manually, in accordance with an application program interface (API) protocol for the database. The efficiency of the query logic underlying the actual query is dependent in part on the size and complexity of the schema of the database and in part on the query logic used. Accordingly, query efficiency may be adversely affected by persistent data growth.

In particular, in some cases, persisted data growth results in potentially heavier queries (e.g., queries designed to process large amounts of data), which are generally known to have slower execution times. The slower execution times may be attributed to the large amount of data the query needs to process. Additionally, in some cases, persisted data growth results an increase in the complexity of existing queries. In particular, a query may be built based on fields from one or more tables. Accordingly, as more tables are added, the number of tables from which a query needs to retrieve information for processing may increase, which, in some cases, may result in slower execution times. Further, increases in persisted data may increase the number of parallel use cases for data consumption, or in other words, result in an increase in the number of queries created to be executed in parallel as new tables are added to the database. For example, as more data is persisted (e.g., often in newly-generated tables in the database), additional queries for retrieving and processing this data may be created. Each new query created may require computing resources, such as memory and central processing unit (CPU) to execute.

In parallel query processing, computing resources of a database system may be available to execute multiple queries at the same time. However, there may be a finite number of compute resources available to execute queries, and therefore, there may be a practical limit to how many queries can be executed in parallel.

Therefore, in some cases, there may be a maximum number of queries allowed to execute in parallel. In such cases, when the maximum number of queries that can be executed in parallel are already being executed, any newly-created queries may be routed to a query queue and expected to wait for processing. In particular, a queue may be allocated a portion of available memory of the database system for holding one or more queries until compute resources are available to process the queries.

Query duration may refer to the duration of time from when the query is admitted for execution, to the time the result of the query is returned. In particular, query duration may include both the time it takes to execute the query as well as the amount of time the query has to wait in the queue. For an end user, query duration is what matters, as it equates to the time the user has to wait for the query to be executed. For certain queries, a user may expect that they be executed quickly, with a low query duration, such as for lightweight queries (e.g., queries which require a minimal amount of memory and/or CPU to process). However, query duration for such lightweight queries may be large in situations where computing resources are tied up by heavyweight queries (e.g., queries which require a large amount of memory and/or CPU to process) that take a long time to execute, thereby causing the lightweight query to wait in the queue until the heavyweight queries complete execution and compute resources are again available.

Accordingly, techniques for improving query throughput, and more specifically, query throughput of lightweight queries, may be desirable.

### SUMMARY

The technology described herein provides a method for query execution. The method generally includes receiving a first query requesting retrieval of first data from a database, admitting the first query to a fast resource pool for execution, wherein the fast resource pool is configured with one or more thresholds for execution, executing the first query in the fast resource pool using resources allocated to the fast resource pool, during execution of the first query in the fast resource pool, determining the one or more thresholds for execution have been exceeded, admitting the first query to a slow resource pool for execution, and executing the first query in the slow resource pool using resources allocated to the slow resource pool.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 illustrates components of an example system in which an embodiment may be implemented.

FIG. 2 depicts an example user interface (UI) for configuring fast and slow resource pools, according to an example embodiment of the present disclosure.

FIG. 3 illustrates an example workflow for query execution using a dual-resource pool design, according to an example embodiment of the present disclosure.

FIG. 4 is a flowchart illustrating a process for query execution, according to an example embodiment of the present disclosure.

### DETAILED DESCRIPTION

Aspects of the present disclosure introduce techniques for improving data query throughput using a dual resource pool design, for example, using both a fast resource pool and a slow resource pool.

A resource pool is a pre-allocated subset of resources (e.g., memory, central processing unit (CPU), and/or input/output operations per second (IOPS) resources) of a system, which has an associated queue. Each resource pool may be configured with pre-determined CPU and/or memory allocation amounts based, at least in part, on the total resources available for utilization. In certain aspects, a fast resource pool is configured with less CPU and/or memory for query execution, as well as less execution time, as compared to a slow resource pool. Thus, a resource-greedy query (interchangeably referred to herein as a “heavyweight query”) admitted to the fast resource pool for execution may fail during execution, as the query requires additional resources (and/or execution time) beyond those allocated to the fast resource pool.

According to certain aspects described herein, each query submitted for processing is first admitted to the fast resource pool for execution. In other words, each query submitted for processing may be assumed to be a lightweight query (excluding, in some cases, queries initially analyzed and determined to exceed fast resource pool limits, as described in more detail below). A query which is executed in the fast resource pool and exceeds configurable limits (e.g., resources allocated and/or execution time) of the fast resource pool is subsequently admitted for processing in the slow resource pool. Using such a dual resource pool design may prevent heavyweight queries from exhausting resources of a resource pool thereby causing, in some cases, a delay in processing other queries, including lightweight queries, waiting on the queue. In particular, the dual resource pool design described herein allows for query isolation such that heavyweight queries do not throttle query duration time of lightweight queries. Accordingly, query duration time of a lightweight query may be independent of the query duration time needed to execute one or more other queries, including heavyweight queries, submitted for processing.

As an illustrative example, a fast resource pool may be pre-configured with a memory limit of 33 megabytes (MB) applied to queries executing in the fast resource pool, as well as a maximum number of concurrently running queries equal to three. Thus, where a lightweight query is submitted for processing and three resource-greedy queries (e.g., in this case, queries requesting greater than 33 MB of memory for execution) are currently being executed in the fast resource pool, the lightweight query waits on queue until processing. In a shared resource pool design (e.g., a non-dual resource pool), the lightweight query submitted for processing is delayed as the three resource-greedy queries submitted prior to the lightweight query are likely to exhaust resources of the resource pool, thereby increasing an amount of time the lightweight query is expected to wait on queue. However, with the dual resource pool design described herein, the lightweight query submitted for processing does not experience such delay. In particular, after 33 MB of memory have been used for execution of each of the three concurrently executing queries, each query is removed from the fast resource pool and admitted to the slow resource pool (or its queue) for processing. The lightweight query, at most, waits on queue for a maximum amount of time needed to exhaust 33 MB of memory (assuming, for this case, the query is the only query admitted in the queue).

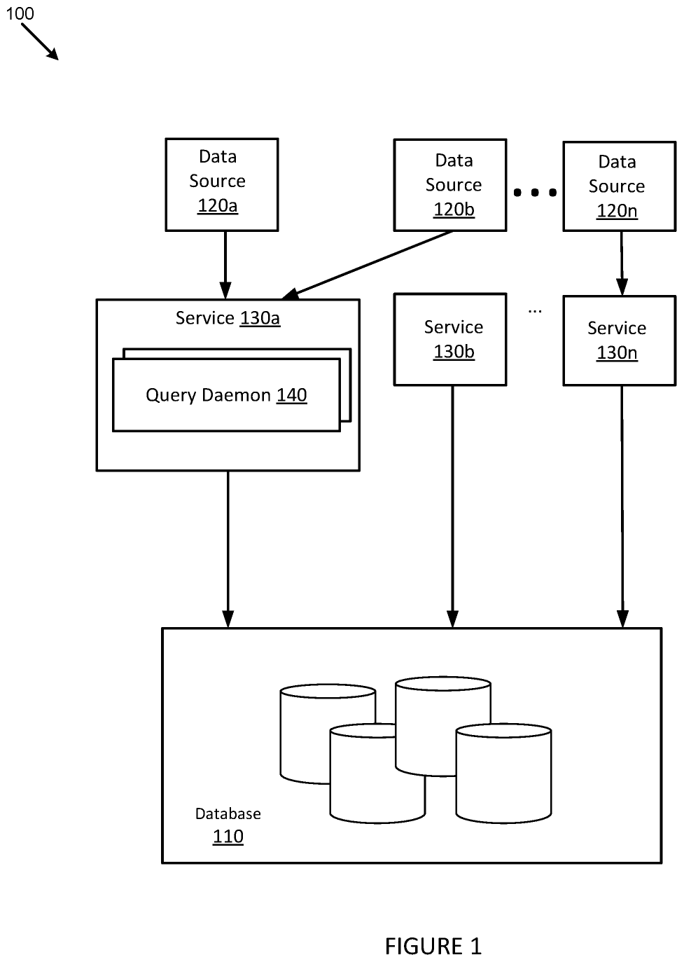

FIG. 1 illustrates components of a system 100 in which an embodiment may be implemented. As shown, system 100 includes a database 110, multiple data sources 120 (e.g., data sources 120a, 120b, . . . 120n), and multiple database management services 130 (e.g., database management services 130a, 130b, 130n). Though multiple data sources 120 and multiple database management services 130 are shown, it should be noted that there may be any number of data sources or database management services in system 100.

Database 110 may include any suitable non-volatile data store for organizing and storing data from the multiple data sources 120. For example, in some embodiments, database 110 may be implemented as software-defined storage such as VMware Virtual Storage Area Network (SAN) that clusters together server-attached hard disks and/or solid state drives (HDDs and/or SSDs), to create a flash-optimized, highly resilient shared datastore designed for virtual environments. In some embodiments, database 110 may be implemented as one or more storage devices, for example, one or more hard disks, flash memory modules, solid state disks, and optical disks (e.g., in a computing device, server, etc.). In some embodiments, database 110 may include a shared storage system having one or more storage arrays of any type such as a network-attached storage (NAS) or a block-based device over a SAN. In some embodiments, database 110 is a write-optimized database. Further, database 110 may be implemented as a key-value store. Database 110 may store data from one or more data sources 120.

Each data source 120 may correspond to one or more physical devices (e.g., servers, computing devices, etc.) or virtual devices (e.g., virtual computing instances, containers, virtual machines (VMs), etc.). For example, a physical device may include hardware such as one or more CPUs, memory, storage, and physical network interface controllers (PNICs). A virtual device may be a device that represents a complete system with processors, memory, networking, storage, and/or a basic input/output system (BIOS), that runs on a physical device. For example, the physical device may execute a virtualization layer that abstracts processor, memory, storage, and/or networking resources of the physical device into one more virtual devices. Each data source 120 may generate data that is loaded into database 110.

Each database management service 130 may be a process or application executing on one or more physical devices or virtual devices. In certain embodiments, a database management service 130 may execute on the same device as a data source 120. In certain embodiments, a database management service 130 may execute on a separate device from the data source 120. As discussed, a database management service 130 may be an automatic service, or a manual service (e.g., directed by a human).

Each database management service 130 may be coupled (e.g., via a network, as running on the same device, etc.) to one or more data sources 120 and to the database 110 (e.g., via a network). Further, each database management service 130 may be configured to generate and perform operations on database 110. For example, a given database management service 130 may be configured to query for a value associated with a key stored in database 110, insert (e.g., replace) a value (e.g., from a data source 120) associated with a key in database 110, and delete a value associated with a key in database 110. In certain embodiments, query, insert, and delete operations may be operations exposed by an API of database 110.

In certain embodiments, database management service 130 is a Massive Parallel Processing (MPP) query execution engine where query operations are performed by one or more query daemons 140. MPP enables fast execution of the most complex queries operating on large amounts of data. In certain embodiments, query daemons 140 run on one or more physical devices. One example of query daemon 140 that may be used is Impala™ daemon (also known as impalad) provided as part of the Apache® Impala™ solution made commercially available from The Apache Software Foundation of Wilmington, Del.

In certain embodiments, query daemon 140 is configured to perform functions, such as, query planning, query coordinating, and/or query execution. In particular, query planning includes parsing out a query received by query daemon 140 for processing and developing a sequence of steps (e.g., a query execution plan) used to access data in database 110 for execution of the query. In certain embodiments, query daemon 140 estimates a number of resources needed for execution of the query based on the query execution plan, and more specifically, based on locations where the data to be retrieved for the query is stored in database 110. As described in more detail below, query daemon 140 may determine to admit the query to a fast resource pool or a slow resource pool based on the number of resources initially estimated by query daemon 140 for execution of the query.

Although not illustrated in FIG. 1, a dual resource pool design, including both a fast resource pool and a slow resource pool, may be configured for executing queries received by one or more query daemons 140. As mentioned, a resource pool represents an instance of available computing resources. In certain embodiments, available computing resources include hardware resources, such as, CPUs, memory, and/or IOPS resources, of a physical device (e.g., servers, computing devices, etc.). With a dual resource pool design, available resources are divided between two resource pools. In particular, according to aspects described herein, available resources for query execution are divided between a fast resource pool and a slow resource pool.

Resource pools allow for the delegation of control over available computing resources. In particular, when creating a fast resource pool, a user may exercise control over the available resources by configuring the fast resource pool with only a subset of the available resources, such that only queries which require less resources than the allocated amount are successfully executed in the fast resource pool. Similarly, a user may configure the slow resource pool with all or a subset of the remainder of the available resource (e.g., amount of resources remaining after configuring the fast resource pool). In some cases, configuring a resource pool with a limited number of resources includes setting one or more limits for the resource pool. In certain embodiments, a user configures a resource pool with such limits through a user interface (UI), for example, provided at a user device (e.g., computer, tablet, etc.).

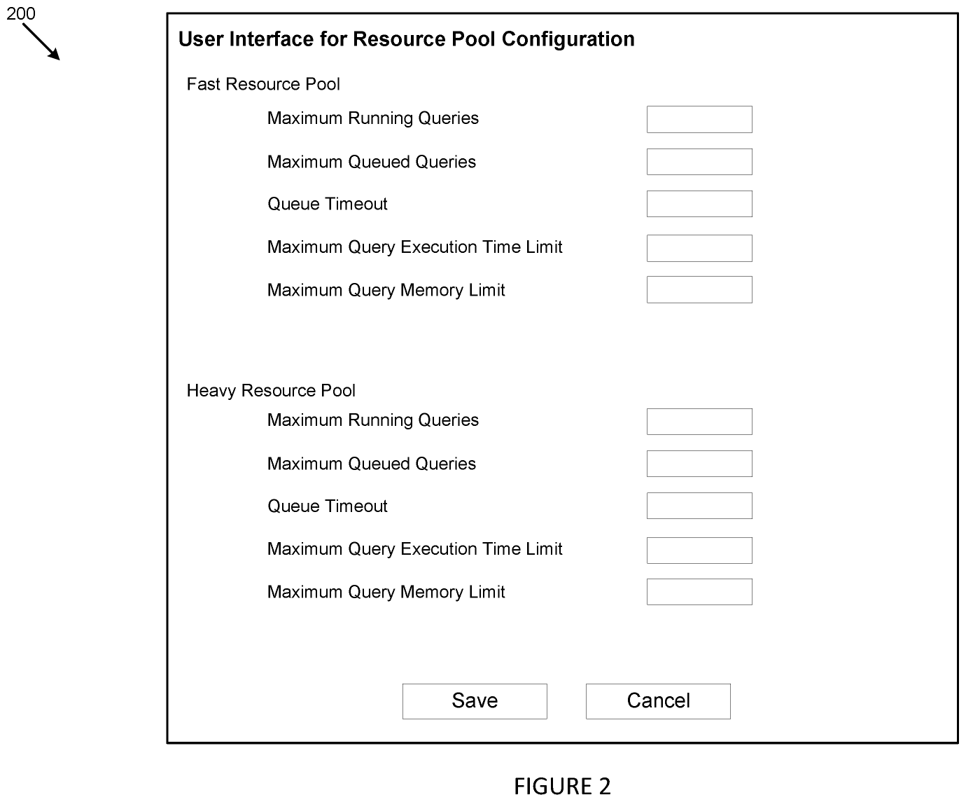

FIG. 2 depicts an example UI 200 for configuring fast and slow resource pools, according to an example embodiment of the present disclosure. Example UI 200 provides a point of interaction between a user of the user device and the user device itself. In particular, a user of the user device uses example UI 200 to set one or more limits for each of the fast and slow resource pools. The limits configured for each resource pool may include a maximum number of running queries and/or queued queries allowed for the resource pool, a queue timeout, a maximum query execution time limit, and/or a maximum query memory limit. Such values set by the user, however, remain within available resource limitations for query execution. For example, where only 150 MB of memory is available, a user may configure an aggregate amount of resources between the fast resource pool and slow resource pool below or equal to 150 MB.

As show in FIG. 2, a maximum running queries value entered in example UI 200 indicates a threshold number of queries that may concurrently run in a resource pool. The threshold number of queries that may concurrently run in a resource pool can be specified by an integer greater than or equal to one. For example, where a user configures the fast resource pool with a value of two, only two queries may be running simultaneously, and any additional queries admitted to the resource pool wait on a queue associated with the resource pool.

Similarly, a maximum queued queries value entered in example UI 200 indicates a threshold number of queries that may be queued for a resource pool. The threshold number of queries that may be queued for a resource pool can be specified by an integer greater than or equal to one. As mentioned, a queue is allocated a portion of available memory for holding queries until they are admitted for processing. Thus, the threshold number of queries that may be queued for a resource pool may be based, at least in part, on the available memory. As described in more detail below, where the threshold number of queued queries has been met and a new query is admitted for execution, the query admitted for execution is rejected (e.g., by query daemon 140), as no additional capacity in the queue exists at the time of submission.

A queue timeout value entered in example UI 200 indicates a threshold amount of time a query may be queued while waiting for execution in the resource pool prior to timing out. In certain embodiments, the queue timeout value can be specified in terms of milliseconds, seconds, minutes, etc. The timeout of a query causes a cancellation of the query waiting to be executed. In certain embodiments, the timeout of a query causes a timeout message to be communicated to a user which previously requested execution of the query. As used herein, the time period for which a query is on queue waiting to be executed includes the time period between when the query is admitted to the queue and when query execution begins. In other words, the time period for which a query is on the queue waiting to be executed may be independent of the time the query takes to execute once execution has begun.

Similarly, a maximum query execution time limit value entered in example UI 200 indicates a threshold amount of time a query may be executed in a resource pool prior to timing out. In certain embodiments, the maximum query execution time limit value is specified in terms of milliseconds, seconds, minutes, etc. As used herein, query execution time includes the time period between when execution of the query begins and when query execution is complete. In other words, query execution time may be independent of the time the query is on the queue waiting to be executed.

A maximum query memory limit value entered in example UI 200 indicates a maximum amount of memory to be applied to each query executing in a resource pool. In certain embodiments, this memory limit value is specified in terms of bits, bytes, MB, gigabytes (GB), etc.

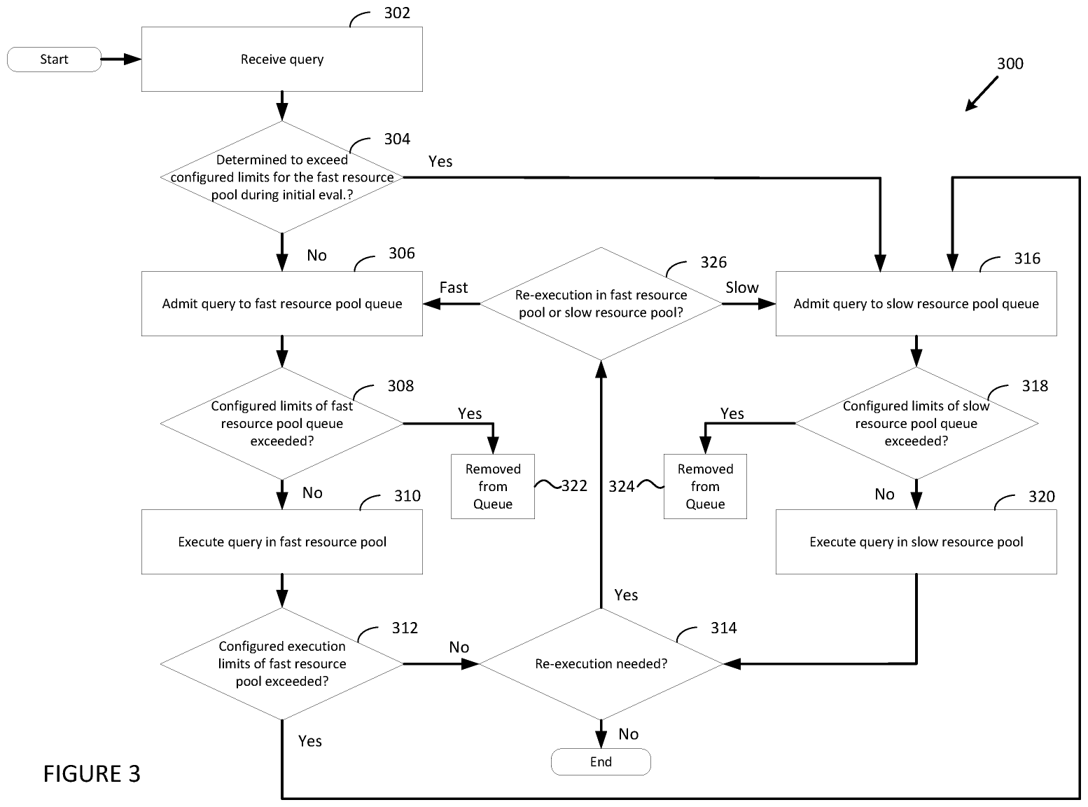

Accordingly, a user may configure a maximum query execution time limit value, a maximum query memory limit value, or both a maximum query execution time limit value and a maximum query memory limit value. As described in more detail below with respect to FIG. 3, where both a maximum query execution time limit value and a maximum query memory limit value are configured by a user, a query executed in the resource pool is determined to be a query which exceeds limits of the resource pool when either the maximum query execution time limit value or maximum query memory limit value is reached. As an illustrative example, a resource pool is configured with a maximum query execution time limit of 600 seconds and a maximum query memory limit of 30 MB. Where a query is executed and needs more than 600 seconds to complete execution, the query is determined to be a query which exceeds the limits of the resource pool even in cases where the memory utilized for execution of the query is less than 30 MB of memory. Similarly, where the query is executed and needs more than 30 MB to complete execution, the query is determined to be a query which exceeds the limits of the resource pool even in cases where the query has been executing for less than 600 seconds.

According to certain aspects, values entered into a UI used to configure a fast resource pool and a slow resource pool, such as example UI 200, are used to determine (1) which resource pool the query is to be executed in, (2) which resource pool the query is to be re-executed in, and/or (3) whether the query may execute in the determined resource pool, or at least, be admitted for execution in its associated queue.

FIG. 3 illustrates an example workflow 300 for query execution using a dual-resource pool design, according to an example embodiment of the present application. Workflow 300 may be used to execute one or more queries while improving query throughput. In particular, workflow 300 may be used to support the execution of a query workload in a balanced manner such that lightweight queries in the workload are not unduly delayed. To support improved query throughput, workflow 300 may assume each query submitted for processing is a lightweight query (excluding, in some cases, queries initially analyzed and determined to exceed fast resource pool limits) and, accordingly, admit such queries to a fast resource pool for execution. A query which is executed in the fast resource pool and exceeds configurable limits (e.g., resources allocated and/or execution time) of the fast resource pool is subsequently admitted for processing in the slow resource pool. Presuming each query admitted for processing is a lightweight query may guarantee immediate and quick execution of such lightweight queries. However, where a query proves to be more resource-greedy (e.g., is a “heavyweight query” as opposed to a “lightweight query”), such queries are transferred to a slow resource pool for execution. Execution of the resource-greedy query in the fast resource pool is cancelled thereby allowing a next query to be processed without unnecessary delay from the resource-greedy query. In certain embodiments, workflow 300 of FIG. 3 is performed, for example, by database management service 130 and query daemon 140 illustrated in FIG. 1.

Workflow 300 begins, at operation 302, by query daemon 140 receiving a query for execution, the query requesting the retrieval (and/or processing) of information from a database, such as database 110 illustrated in FIG. 1. At operation 304, query daemon 140 evaluates the received query. In particular, at operation 304, query daemon 140 determines whether the received query is likely to exceed configured limits for the fast resource pool. As described with respect to FIG. 2, the limits configured for each resource pool may include a maximum number of running queries and/or queued queries allowed for the resource pool, a queue timeout, a maximum query execution time limit, and/or a maximum query memory limit. Accordingly, at operation 304, query daemon 140 estimates an amount of resources and/or an amount of time needed to execute the query received at operation 302. In certain embodiments, estimating an amount of resources and/or an amount of time needed to execute the query received at operation 302 includes parsing the query received at operation 302, developing a plan for executing the query (e.g., determining locations, such as, tables where the data is to be retrieved), and estimating a number of resources needed for execution of the developed plan. In some cases, based on the number of estimated resources, query daemon 140 determines an estimation of an amount of time needed to execute the query received at operation 302. In some cases, based on the estimated time and/or resources for execution of the query, query daemon 140 concludes the query is likely to exceed configured limits of the fast resource pool (e.g., (estimated query execution time>configured maximum query execution time limit) and/or (estimated memory resources>configured maximum query memory limit)). In some other cases, based on the estimated time and/or resources for execution of the query, query daemon 140 concludes the query is not likely to exceed configured limits of the fast resource pool (e.g., (estimated query execution time≤configured maximum query execution time limit) and/or (estimated memory resources≤configured maximum query memory limit)).

Where, at operation 304, query daemon 140 determines the query is likely to exceed configured limits of the fast resource pool, the query is admitted to a queue associated with the slow resource pool. Submission of the query to the slow resource pool queue is described in more detail below.

Where, at operation 304, query daemon 140 determines the query is not likely to exceed configured limits of the fast resource pool, the query is admitted to a queue associated with the fast resource pool. As mentioned, each resource pool has an associated queue with its own configuration. In particular, the fast resource pool and the slow resource pool each have their own associated queue, and each queue is configured with, at least, a queue timeout value and a threshold value of queued queries (e.g., as illustrated in FIG. 2).

In some cases, when the query is admitted to the fast resource pool queue at operation 306, the number of queries currently residing in the fast resource pool is equal to the threshold value of queued queries configured for the fast resource pool queue (e.g., five queries are on queue and the configured threshold value of queued queries is equal to five). Accordingly, when the query is admitted, configured limits of the fast resource pool queue, and more specifically, the number of queries queued in the fast resource pool queue at a time, is exceeded, at operation 308. Accordingly, at operation 322, the query admitted to the queue at operation 306 is rejected/removed from the queue.

In certain aspects, when the query is rejected/removed from the queue at operation 306, retry logic may be applied. In particular, retry logic may be configured to re-admit a failed query (e.g., a query rejected/removed from the queue) until a maximum retry limit is reached, the maximum retry limit limiting the number of attempts the query can be re-admitted to a queue. In some cases, the retry logic may include an exponential backoff algorithm. The idea behind exponential backoff is to use progressively longer waits between retries for consecutive error responses (e.g., between consecutive rejections/removals of a query being admitted to the queue).

In some other cases, when the query is admitted to the fast resource pool queue at operation 306, the number of queries currently residing in the fast resource pool queue is less than the threshold value of queued queries configured for the fast resource pool queue (e.g., three queries are on queue and the configured threshold value of queued queries is equal to five). Accordingly, when the query is admitted, the query is not initially rejected. However, the query admitted on the queue may exceed configured limits of the fast resource pool queue where the admitted query is waiting on the queue for a time period greater than the queue timeout threshold (e.g., described with respect to FIG. 2) configured for the fast resource pool. For example, where the query is admitted and waits on the queue for greater than 30 minutes, where the queue timeout threshold is configured to be 30 minutes, at operation 306, the query is considered, at operation 308, to exceed the configured limits of the fast resource pool queue. Accordingly, at operation 322, the query admitted to the queue at operation 306 is removed from the queue. In certain aspects, where a query admitted on the fast resource pool queue exceeds configured limits of the queue and is removed, retry logic may be applied. However, because the query was admitted to the fast resource pool queue at operation 306, the retry logic applied may retry the query in the fast resource pool until the query begins execution in the fast resource pool (e.g., described with respect to operation 310) or alternatively fails due to reaching a threshold amount of retries configured for the query.

Where at operation 308, configured limits of the fast resource pool queue are not exceeded (e.g., the number of queries in the queue is less than the threshold number of queries allowed to be in the queue and the time the query is in the queue is less than the queue timeout threshold), at operation 310, the query is executed in the fast resource pool. More specifically, where resources become available for execution of the query in the fast resource pool, the query is executed.

As an illustrative example, the fast resource pool may be configured to execute a maximum of three queries at a time. When the query is submitted to the fast resource pool queue at operation 306, three queries may be currently executing in the fast resource pool and no queries may be waiting in the queue to be executed. Accordingly, when one of the three queries completes execution, the query is removed from the fast resource pool queue and begins execution, for example, as one of the three queries allowed to execute at a given time.

At operation 312, query daemon 140 determines whether configured execution limits of the fast resource pool are exceeded during execution of the query. In particular, at operation 312, query daemon 140 determines (1) whether the query was able to complete execution within the maximum query execution time limit configured for the fast resource pool and/or (2) whether the query was able to complete execution before the maximum query memory limit configured for the fast resource pool was reached. For example, the fast resource pool may be configured with a maximum query memory limit of 30 MB. Where the query is executed at operation 310 and reaches utilization of 30 MB prior to completion of the execution of the query, query daemon 140 determines, at operation 312, that configured execution limits of the fast resource pool have been exceeded. Accordingly, the query is determined to be a heavyweight query, thereby voiding the initial assumption that the query is a lightweight query.

Where, at operation 312, the configured execution limits of the fast resource pool are exceeded by execution of the query, the query is subsequently admitted to the slow resource pool queue, at operation 316. Similar to operation 306, in some cases, when the query is admitted to the slow resource pool queue, the number of queries currently residing in the slow resource pool is equal to the threshold value of queued queries configured for the slow resource pool queue (e.g., five queries are on queue and the configured threshold value of queued queries is equal to five). Accordingly, when the query is submitted, configured limits of the slow resource pool queue, and more specifically, the number of queries queued in the slow resource pool queue at a time, is exceeded, at operation 318. Accordingly, at operation 324, the query admitted to the queue at operation 316 is rejected/removed from the queue.

As mentioned above, in certain aspects, when a query is rejected/removed from a queue, such as removal of a query from the queue at operation 324, retry logic may be applied. In particular, retry logic may be configured to re-admit a failed query (e.g., a query rejected/removed from the queue) until a maximum retry limit is reached, the maximum retry limit limiting the number of attempts the query can be re-admitted to a queue. In some cases, the retry logic may include an exponential backoff algorithm.

In some other cases, when the query is admitted to the slow resource pool queue at operation 316, the number of queries currently residing in the slow resource pool queue is less than the threshold value of queued queries configured for the slow resource pool queue (e.g., three queries are on queue and the configured threshold value of queued queries is equal to five). Accordingly, when the query is admitted, the query is not initially rejected. However, the query admitted on the queue may exceed configured limits of the slow resource pool queue where the admitted query is waiting on the queue for a time period greater than the queue timeout threshold (e.g., described with respect to FIG. 2) configured for the slow resource pool. Accordingly, where the queue timeout threshold is exceeded, at operation 324, the query admitted to the queue at operation 316 is removed from the queue. In certain aspects, where a query admitted on the slow resource pool queue exceeds configured limits of the queue and is removed, retry logic may be applied. However, because the query was admitted to the slow resource pool queue at operation 316, the retry logic applied may retry the query in the slow resource pool until the query begins execution in the slow resource pool (e.g., described with respect to operation 320) or alternatively fails due to reaching a threshold amount of retries configured for the query.

Where at operation 318, configured limits of the slow resource pool queue are not exceeded (e.g., the number of queries in the queue is less than the threshold number of queries allowed to be in the queue and the time the query is in the queue is less than the queue timeout threshold configured for the slow resource pool), at operation 320, the query is executed in the slow resource pool. More specifically, where resources become available for execution of the query in the slow resource pool, the query is executed.

Although not shown in FIG. 3, in some cases (e.g., as illustrated in FIG. 2), where a maximum query execution time limit is configured for the slow resource pool, query daemon 140 may evaluate whether execution of the query in the slow resource pool exceeds this defined limit. However, unlike operation 312, where query daemon 140 determines whether configured execution limits of the fast resource pool have been exceeded for purposes of avoiding query duration time of queries waiting on queue, determination of whether configured execution limits of the slow resource pool have been exceeded may be for a different purpose. In particular, the maximum query execution time limit configured for the slow resource pool may be configured to be a significantly high value such that execution of a query may not reach this threshold unless an unexpected error exists in the system. Accordingly, it may be assumed for purposes of the illustration of FIG. 3, that no error exists, thus, execution of queries in the slow resource pool are executed within the execution limits configured for the slow resource pool.

At operation 314, after execution of the query in the slow resource pool at operation 320, a database management service (e.g., database management service 130 illustrated in FIG. 1 which mediates communication between query daemon 140 and an end user) determines whether re-execution of the query is needed. For example, re-execution of a query may be needed where incorrect and/or incomplete information is retrieved from database 110.

In some cases, re-execution of the query may not be needed; thus, workflow 300 is complete. However, in some other cases, re-execution of the query may be needed, and at operation 326, database management service 130 determines whether to re-execute the query in the fast resource pool or the slow resource pool.

Determining whether re-execution is needed may also occur at operation 314 after the query is executed completely at operation 310, and query daemon 140 determines, at operation 312, that configured execution limits of the fast resource pool have not been exceeded.

At operation 326, query daemon 140 determines whether to re-execute the query in the fast resource pool or the slow resource pool based on (1) the initial evaluation of the query by query daemon 140 at operation 304 and/or (2) whether the query exceeded execution limits of the fast resource pool when executed in the fast resource pool at operation 310.

In some cases, where query daemon 140 previously admitted the query to the slow resource pool after making the determination, at operation 304, that the query would likely exceed configured limits for the fast resource pool, to re-execute the query, query daemon 140 re-admits the query to slow resource pool queue at operation 316. In some cases, where query daemon 140 previously admitted the query to the fast resource pool after making the determination, at operation 304, that the query was not likely to exceed configured limits for the fast resource pool and execution of the query did not exceed execution limits of the fast resource (e.g., determined at operation 312), to re-execute the query, query daemon 140 re-admits the query to fast resource pool queue at operation 306. In some cases, where query daemon 140 previously admitted the query to the fast resource pool after making the determination, at operation 304, that the query was not likely to exceed configured limits for the fast resource pool yet execution of the query did exceed execution limits of the fast resource (e.g., determined at operation 312) therefore the query was admitted to the slow resource pool, to re-execute the query, query daemon 140 re-admits the query to the slow resource pool queue at operation 316.

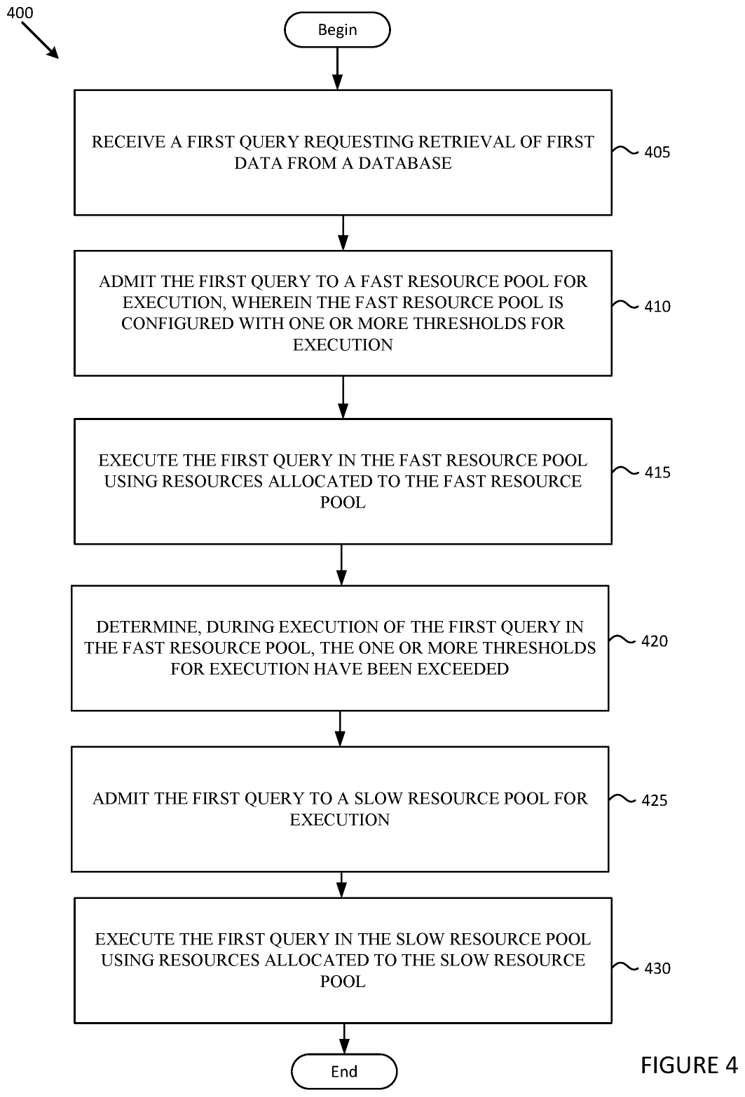

FIG. 4 is a flowchart illustrating a process 400 for query execution, according to an example embodiment of the present disclosure. In certain embodiments, process 400 may be performed by a query daemon for retrieval of information in a database requested by one or more queries. For example, process 400 may be performed by query daemon 140 for retrieval of data from database 110 as shown in FIG. 1.

Process 400 may begin, at block 405, by query daemon 140 receiving a first query requesting retrieval of first data from a database.

At block 410, query daemon 140 admits the first query to a fast resource pool for execution, wherein the fast resource pool is configured with one or more thresholds for execution. In certain embodiments, the one or more thresholds for execution include, at least one of: a threshold amount of time a query may be executed in the fast resource pool or a threshold amount of memory resources to be applied for execution of a query in the fast resource pool. In certain embodiments, admitting the first query to the fast resource pool for execution comprises admitting the first query to a fast resource pool queue associated with the fast resource pool, wherein submission of the first query to the fast resource pool queue increases a number of queries in the fast resource pool queue to a first value below or equal to a threshold value of queued queries configured for the fast resource pool.

In certain embodiments, prior to admitting the first query to the fast resource pool for execution at block 410, query daemon 140 estimates, at least one of a number of resources or time needed to execute the first query and compares the at least one of the estimated number of resources or estimated time needed to execute the first query to the one or more thresholds for execution. Query daemon 140 may admit the first query to the fast resource pool for execution based, at least in part, on the comparison.

At block 415, query daemon 140 executes the first query in the fast resource pool using resources allocated to the fast resource pool.

At block 420, query daemon 140 determines, during execution of the first query in the fast resource pool, the one or more thresholds for execution have been exceeded. In certain embodiments, determining the one or more thresholds for the execution have been exceeded comprise determining, at least one of: the first query has been executing for the threshold amount of time without completion of the first query, or the first query has exhausted the threshold amount of memory resources without the completion of the first query.

At block 425, query daemon 140 admits the first query to a slow resource pool for execution and, at block 430, executes the first query in the slow resource pool using resources allocated to the slow resource pool. In certain embodiments, admitting the first query to the slow resource pool for execution includes cancelling execution of the first query in the fast resource pool, thereby making available one or more resources allocated to the fast resource pool for execution of a second query admitted to the fast resource pool. In certain embodiments, admitting the first query to the slow resource pool for execution comprises admitting the first query to a slow resource pool queue associated with the slow resource pool, wherein submission of the first query to the slow resource pool queue increases a number of queries in the slow resource pool queue to a second value below or equal to a threshold value of queued queries configured for the slow resource pool.

Certain embodiments as described above involve a hardware abstraction layer on top of a host computer. The hardware abstraction layer allows multiple contexts or virtual computing instances to share the hardware resource. In one embodiment, these virtual computing instances are isolated from each other, each having at least a user application running therein. The hardware abstraction layer thus provides benefits of resource isolation and allocation among the virtual computing instances. In the foregoing embodiments, VMs are used as an example for the virtual computing instances and hypervisors as an example for the hardware abstraction layer. As described above, each VM includes a guest operating system in which at least one application runs. It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The computer readable media may be non-transitory. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, solid state disk (SSD or flash drive), network attached storage (NAS), read-only memory, random-access memory, NVM (non-volatile memory such as Phase Change Memory or 3D-xPoint memory), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method for query execution, the method comprising:
receiving a first query requesting retrieval of first data from a database;
admitting the first query to a fast resource pool for execution, wherein the fast resource pool is configured with one or more thresholds for execution;
executing the first query in the fast resource pool using resources allocated to the fast resource pool;
during execution of the first query in the fast resource pool, determining the one or more thresholds for execution have been exceeded;
based on determining that the one or more thresholds for execution have been exceeded, admitting the first query to a slow resource pool for execution; and
executing the first query in the slow resource pool using resources allocated to the slow resource pool.

2. The method of claim 1, wherein admitting the first query to the slow resource pool for execution comprises:
cancelling execution of the first query in the fast resource pool, thereby making available one or more of the resources allocated to the fast resource pool for execution of a second query admitted to the fast resource pool.

3. The method of claim 1, wherein the one or more thresholds for execution comprise, at least one of:
a threshold amount of time a query may be executed in the fast resource pool; or
a threshold amount of memory resources to be applied for execution of a query in the fast resource pool.

4. The method of claim 3, wherein determining the one or more thresholds for execution have been exceeded comprise determining, at least one of:
the first query has been executing for the threshold amount of time without completion of the first query; or
the first query has exhausted the threshold amount of memory resources without the completion of the first query.

5. The method of claim 1, further comprising:
prior to admitting the first query to the fast resource pool for execution, estimating, at least one of a number of resources or time needed to execute the first query; and
comparing the at least one of the estimated number of resources or the estimated time needed to execute the first query to the one or more thresholds for execution, wherein admitting the first query to the fast resource pool for execution is based, at least in part, on the comparison.

6. The method of claim 1, wherein:
admitting the first query to the fast resource pool for execution comprises admitting the first query to a fast resource pool queue associated with the fast resource pool, wherein submission of the first query to the fast resource pool queue increases a number of queries in the fast resource pool queue to a first value below or equal to a threshold value of queued queries configured for the fast resource pool; and
admitting the first query to the slow resource pool for execution comprises admitting the first query to a slow resource pool queue associated with the slow resource pool, wherein submission of the first query to the slow resource pool queue increases a number of queries in the slow resource pool queue to a second value below or equal to a threshold value of queued queries configured for the slow resource pool.

7. A system comprising:
one or more processors; and
at least one memory, the one or more processors and the at least one memory configured to:
receive a first query requesting retrieval of first data from a database;
admit the first query to a fast resource pool for execution, wherein the fast resource pool is configured with one or more thresholds for execution;
execute the first query in the fast resource pool using resources allocated to the fast resource pool;
during execution of the first query in the fast resource pool, determine the one or more thresholds for execution have been exceeded;
based on determining that the one or more thresholds for execution have been exceeded, admits the first query to a slow resource pool for execution; and
execute the first query in the slow resource pool using resources allocated to the slow resource pool.

8. The system of claim 7, wherein the one or more processors and the at least one memory are configured to admit the first query to the slow resource pool for execution by:
cancelling execution of the first query in the fast resource pool, thereby making available one or more of the resources allocated to the fast resource pool for execution of a second query admitted to the fast resource pool.

9. The system of claim 7, wherein the one or more thresholds for execution comprise, at least one of:
a threshold amount of time a query may be executed in the fast resource pool; or
a threshold amount of memory resources to be applied for execution of a query in the fast resource pool.

10. The system of claim 9, wherein the one or more processors and the at least one memory are configured to determine the one or more thresholds for execution have been exceeded by determining, at least one of:
the first query has been executing for the threshold amount of time without completion of the first query; or
the first query has exhausted the threshold amount of memory resources without the completion of the first query.

11. The system of claim 7, wherein the one or more processors and the at least one memory are further configured to:
prior to admitting the first query to the fast resource pool for execution, estimating, at least one of a number of resources or time needed to execute the first query; and
comparing the at least one of the estimated number of resources or the estimated time needed to execute the first query to the one or more thresholds for execution, wherein admitting the first query to the fast resource pool for execution is based, at least in part, on the comparison.

12. The system of claim 7, wherein the one or more processors and the at least one memory are configured to:
admit the first query to the fast resource pool for execution by admitting the first query to a fast resource pool queue associated with the fast resource pool, wherein submission of the first query to the fast resource pool queue increases a number of queries in the fast resource pool queue to a first value below or equal to a threshold value of queued queries configured for the fast resource pool; and
admit the first query to the slow resource pool for execution by admitting the first query to a slow resource pool queue associated with the slow resource pool, wherein submission of the first query to the slow resource pool queue increases a number of queries in the slow resource pool queue to a second value below or equal to a threshold value of queued queries configured for the slow resource pool.

13. A non-transitory computer-readable medium comprising instructions that, when executed by one or more processors of a computing system, cause the computing system to perform operations for query execution, the operations comprising:
receiving a first query requesting retrieval of first data from a database;
admitting the first query to a fast resource pool for execution, wherein the fast resource pool is configured with one or more thresholds for execution;
executing the first query in the fast resource pool using resources allocated to the fast resource pool;
during execution of the first query in the fast resource pool, determining the one or more thresholds for execution have been exceeded;
based on determining that the one or more thresholds for execution have been exceeded, admitting the first query to a slow resource pool for execution; and
executing the first query in the slow resource pool using resources allocated to the slow resource pool.

14. The non-transitory computer-readable medium of claim 13, wherein admitting the first query to the slow resource pool for execution comprises:
cancelling execution of the first query in the fast resource pool, thereby making available one or more of the resources allocated to the fast resource pool for execution of a second query admitted to the fast resource pool.

15. The non-transitory computer-readable medium of claim 13, wherein the one or more thresholds for execution comprise, at least one of:
a threshold amount of time a query may be executed in the fast resource pool; or
a threshold amount of memory resources to be applied for execution of a query in the fast resource pool.

16. The non-transitory computer-readable medium of claim 15, wherein determining the one or more thresholds for execution have been exceeded comprise determining, at least one of:
the first query has been executing for the threshold amount of time without completion of the first query; or
the first query has exhausted the threshold amount of memory resources without the completion of the first query.

17. The non-transitory computer-readable medium of claim 13, wherein the operations further comprise:
prior to admitting the first query to the fast resource pool for execution, estimating, at least one of a number of resources or time needed to execute the first query; and
comparing the at least one of the estimated number of resources or the estimated time needed to execute the first query to the one or more thresholds for execution, wherein admitting the first query to the fast resource pool for execution is based, at least in part, on the comparison.

18. The non-transitory computer-readable medium of claim 13, wherein:
admitting the first query to the fast resource pool for execution comprises admitting the first query to a fast resource pool queue associated with the fast resource pool, wherein submission of the first query to the fast resource pool queue increases a number of queries in the fast resource pool queue to a first value below or equal to a threshold value of queued queries configured for the fast resource pool; and
admitting the first query to the slow resource pool for execution comprises admitting the first query to a slow resource pool queue associated with the slow resource pool, wherein submission of the first query to the slow resource pool queue increases a number of queries in the slow resource pool queue to a second value below or equal to a threshold value of queued queries configured for the slow resource pool.
